(19) United States
(12) Patent Application Publication
(10) Pub. No.: US 2017/0066445 A1
(43) Pub. Date: Mar. 9, 2017

(54) VEHICLE CONTROL APPARATUS

(71) Applicant: DENSO CORPORATION, Kariya-city (JP)

(72) Inventor: Toshiya Habu, Kariya-city (JP)

(21) Appl. No.: 15/251,919

(22) Filed: Aug. 30, 2016

(30) Foreign Application Priority Data
Sep. 9, 2015 (JP) 2015-177899

(51) Int. Cl. B60W 30/165; B62D 15/02

(52) U.S. Cl. CPC B60W 30/165; B62D 15/026; B60W 2550/308; B60W 2550/14; B60W 2520/10; B60W 2550/306; B60W 2710/20; B60W 2720/10; B60W 2750/308; B60W 2600/00

(57) ABSTRACT

A vehicle control apparatus includes a branched lane determination section for determining whether an own vehicle lane in which an own vehicle is travelling is a branched lane, a reference line selection section for selecting as a reference line a lane marking on a side opposite to a side on which a branch lane branches from the own vehicle lane, a vehicle control unit for controlling the own vehicle to travel following an object preceding vehicle as a following control object, and a propriety determination section for excluding the object preceding vehicle from being the following control object if the own vehicle lane is determined to be a branched lane and a state quantity based on an offset distance between a movement track of the object preceding vehicle and the reference line exceeds a predetermined threshold.

This application claims priority to Japanese Patent Application No. 2015-177899 filed on Sep. 9, 2015, the entire contents of which are hereby incorporated by reference.

### BACKGROUND OF THE INVENTION

1. Field of the Invention

The present invention relates to a vehicle control apparatus for controlling an own vehicle to travel following a preceding vehicle.

2. Description of Related Art

It is known to perform vehicle control to cause an own vehicle to travel autonomously following a preceding vehicle for the purpose of increasing running safety and reducing burden of a driver of the own vehicle. It is necessary to release such vehicle control when the preceding vehicle has changed lanes or turned right or left.

Japanese Patent Application Laid-open No. 2000-137900 describes a technique in which an object is determined to be a preceding vehicle if this object is within an own vehicle lane area defined based on the travel direction of the own vehicle. In this technique, it is determined whether the following control (control to cause the own vehicle to travel following the preceding vehicle) should be continued based on a result of estimation of whether the lateral position of the preceding vehicle will be within the own vehicle lane area after a predetermined time has passed. If the lateral position of the preceding vehicle is estimated to be within the own vehicle lane area after the predetermined time has passed, the following control is continued. On the other hand, if the lateral position of the preceding vehicle is estimated to be outside the own vehicle lane area after the predetermined time has passed, the following control is released. The lateral position of the preceding vehicle after the predetermined time has passed can be estimated based on the current lateral position of the preceding vehicle and a lateral speed of the preceding vehicle (the moving speed of the preceding vehicle in the direction perpendicular to the travel direction of the own vehicle).

However, the technique described in this patent document has a problem in that when the road on which a vehicle ahead of the own vehicle is running has some specific shapes, there is a concern that this vehicle may continue to be determined as a preceding vehicle even after this vehicle has left the own vehicle lane.

For example, in a case where the own vehicle lane is curved, and a branch lane branches from the own vehicle lane so as to extend in the direction in which the own vehicle travels, a vehicle running ahead of the own vehicle may continue to be erroneously determined as a preceding vehicle even after this vehicle has moved to the branch lane.

### SUMMARY

An exemplary embodiment provides a vehicle control apparatus including:

a preceding vehicle detection section for detecting at least one preceding vehicle travelling ahead of an own vehicle;

a lane marking acquisition section for acquiring a lane marking formed along an own vehicle lane in which the own vehicle is travelling;

a movement track acquisition section for acquiring a movement track of an object preceding vehicle selected from the at least one preceding vehicle;

a vehicle control unit for controlling the own vehicle to travel following the object preceding vehicle as a following control object;

a branched lane determination section for determining whether or not the own vehicle lane is a branched lane;

a reference line selection section for selecting as a reference line the lane marking on a side opposite to a side on which the branch lane branches, and

a propriety determination section for excluding the object preceding vehicle from being the following control object if the own vehicle lane is determined to be a branched lane and a state quantity which is based on an offset distance between the movement track and the reference line exceeds a predetermined threshold.

According to the exemplary embodiment, there is provided a vehicle control apparatus capable of controlling an own vehicle to travel following a preceding vehicle even when the own vehicle is travelling in a branched lane.

Other advantages and features of the invention will become apparent from the following description including the drawings and claims.

### BRIEF DESCRIPTION OF THE DRAWINGS

In the accompanying drawings:

FIG. 1 is a block diagram showing the structure of a vehicle control apparatus according to an embodiment of the invention;

FIG. 2 is a diagram for explaining a situation in which an object preceding vehicle does not move into a branch lane branching from a branched lane;

FIG. 3 is a diagram for explaining a situation in which an object preceding vehicle moves to a branch lane branching from a branched lane;

FIG. 4 is a flowchart showing steps of a control process performed by the vehicle control apparatus;

FIG. 5 is a diagram for explaining a situation in which an object preceding vehicle travelling in a branched lane changes lanes;

FIG. 6 is a diagram for explaining a situation in which an object preceding vehicle moves to a branch lane branching from a branched lane which is a single; and

FIG. 7 is a diagram for explaining an example of setting a following-distance threshold in accordance with the speed of an own vehicle on which vehicle the control apparatus is mounted.

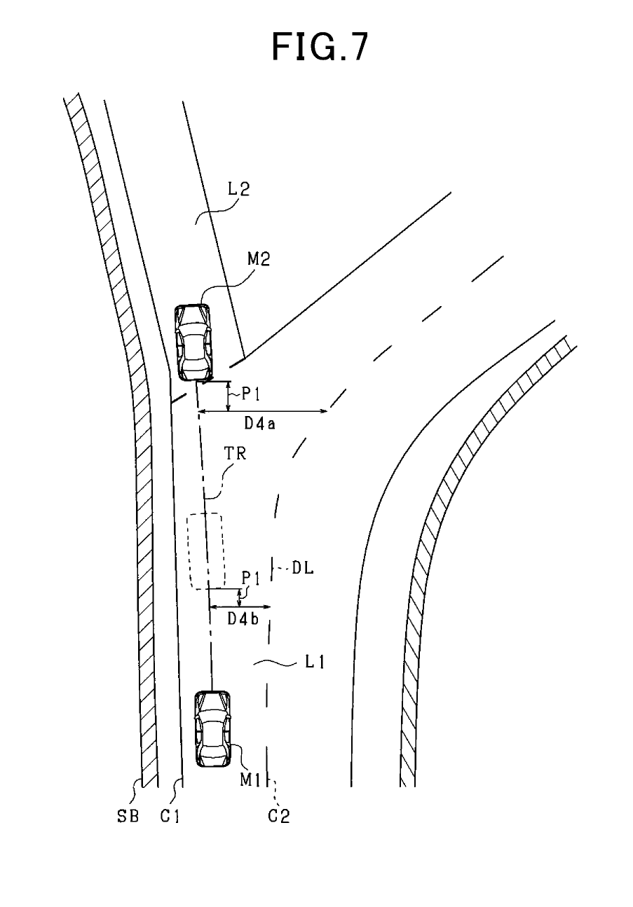

### PREFERRED EMBODIMENTS OF THE INVENTION

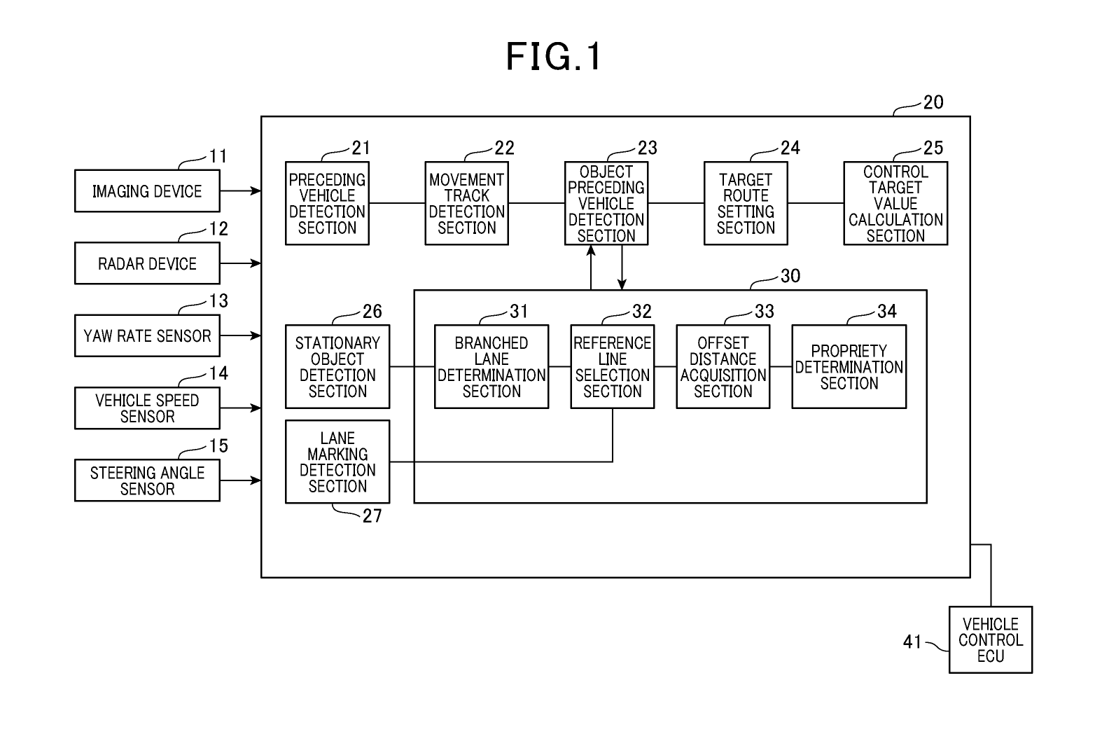

FIG. 1 is a block diagram showing the structure of a vehicle control apparatus 20 according to an embodiment of the invention, which is mounted on an own vehicle.

The vehicle control apparatus 20 is provided with an imaging device 11 and a radar device 12 which are mounted on the own vehicle for detecting objects present around the own vehicle.

The imaging device 11, which is an on-vehicle camera in this embodiment, includes a CCD element, or a CMOS image sensor or an infrared image sensor. The imaging device 11 captures an image of circumference environment of the own vehicle including the road on which the own vehicle is running, generates image data of the captured image, and outputs the image data successively to the vehicle control apparatus 20. In this embodiment, the imaging device 11 is mounted in the vicinity of the upper side of the windshield of the own vehicle to capture an image of a search area which extends ahead of the own vehicle at a predetermined angle to the imaging center axis. The imaging device 11 may be a monocular camera or a stereo camera.

The radar device 12 detects an object by emitting electromagnetic waves as radar signals and receiving the electromagnetic waves reflected from the object. The radar device 12 may be a millimeter-wave radar device. The radar device 12 is mounted on a front part of the own vehicle to scan a scan area which extends ahead of the own vehicle at a predetermined angle to the emission center axis by the radar signals. The radar device 12 generates ranging data based on the time elapsed from when the electromagnetic waves are emitted to when the reflected version of the electromagnetic waves are received, and outputs the ranging data successively to the vehicle control apparatus 20. The ranging data includes a direction of an object, a distance to the object and a relative speed of the object.

The vehicle control apparatus 20 is provided with also a yaw rate sensor 13 for detecting the angular velocity (yaw rate) of the own vehicle, a vehicle speed sensor 14 for detecting the vehicle speed of the own vehicle and a steering angle sensor 15 for detecting the steering angle of the own vehicle.

The vehicle control apparatus 20 is a computer-based unit including a CPU, a ROM, a RAM and an I/O device. The vehicle control apparatus 20 is comprised of a preceding vehicle detection section 21, a movement track acquisition section 22, an object preceding vehicle selection section 23, a target route setting section 24, a control target value calculation section 25, a stationary object acquisition section 26, a lane marking acquisition section 27 and an object preceding vehicle determination unit 30. The functions of these sections and the unit of the vehicle control apparatus 20 are implemented by a program stored the ROM which the CPU executes in accordance with the image data received from the imaging device 11, the ranging data received from the radar device 12 and detection results received from the various sensors mounted on the own vehicle.

The preceding vehicle detection section 21 detects a vehicle running ahead of the own vehicle in the same lane as the own vehicle as a preceding vehicle based on information on an object acquired by the imaging device 11 and the radar device 12. For example, the preceding vehicle detection section 21 detects a preceding vehicle by combining information on an object extracted from the image data received from the imaging device 11 with information on an object extracted from the ranging data received from the radar device 12. Also, a preceding vehicle may be detected using one of information on an object extracted from the image data received from the imaging device 11 and information on an object extracted from the ranging data received from the radar device 12. The information regarding a preceding vehicle detected by the preceding vehicle detection section 21 is supplied to the movement track acquisition section 22.

The movement track acquisition section 22 calculates the position (coordinates) of a detected preceding vehicle at a predetermined cycle based on the ranging data (distance information and lateral position information of the preceding vehicle), and stores the calculated position in the form of time-series data. Further, the movement track acquisition section 22 calculates the movement track of the preceding vehicle based on the time-series data. Information regarding the calculated movement track of the preceding vehicle is supplied to the object preceding vehicle selection section 23. In a case where the movement track acquisition section 22 receives information for each of a plurality of preceding vehicles from the preceding vehicle detection section 21, the movement track acquisition section 22 calculates the movement track of each of the preceding vehicles.

The object preceding vehicle selection section 23 selects, as an object preceding vehicle to which the own vehicle should be controlled to follow, one of preceding vehicles detected by the preceding vehicle detection section 21. For example, of the detected preceding vehicles, the one following distance to which is the shortest is selected as the object preceding vehicle. Information regarding the object preceding vehicle selected by the object preceding vehicle selection section 23 is supplied to the target route setting section 24 and the object preceding vehicle determination unit 30.

The target route setting section 24 sets a target route for the own vehicle based on the movement track of the object preceding vehicle. The control target value calculation section 25 calculates control target values used for the own vehicle to travel along the target route. Specifically, the control target value calculation section 25 calculates a control target value of the speed of the own vehicle used to perform a first control process in which the distance between the object preceding vehicle and the own vehicle is maintained at a predetermined target distance. Further, the control target value calculation section 25 calculates a control target value of the steering amount of the own vehicle used to perform a second control process in which the horizontal position of the own vehicle relative to the travel direction of the object preceding vehicle aligned to that of the object preceding vehicle. These control target values are supplied to and received from a vehicle control ECU 41. The vehicle control ECU 41 adjusts engine braking operation and steering operation based on these control target values.

The stationary object acquisition section 26 calculates a position of a stationary object provided so as to extend along the own vehicle lane based on the ranging data supplied from the radar device 12, and supplies position information of the calculated position to the object preceding vehicle determination unit 30. This position information may be acquired by image-processing the image data supplied from the imaging device 11. Alternatively, this position information may be acquired by combining the ranging data supplied from the radar device 12 with the image data supplied from the imaging device 11.

For example, the stationary objects is a three-dimensional object such as a guardrail or a wall. Further, the stationary object may be objects disposed along the own vehicle lane at regular intervals. Further, the stationary object may be an object disposed on the roadside outside the own vehicle lane. Such an stationary object can be detected when there is no other lane between the own vehicle lane and the stationary object.

The lane marking acquisition section 27 acquires information regarding a lane marking from the image data supplied from the imaging device 11. This acquired information is supplied as the lane marking information to the object preceding vehicle determination unit 30. For example, an edge point is extracted as a candidate of a lane marking from the image data based on a luminance change rate or the like in the horizontal direction of an image. The extracted edge point is stored for each image frame in succession, and the lane marking information is calculated based on a history of the stored edge points. The lane marking acquisition section 27 acquires, as a lane marking, white lines on the right and left sides of the own vehicle lane, a lane division line between the own vehicle lane and a branch lane, or a lane division line between the own vehicle lane and the opposite lane, for example.

When the own vehicle lane is branched lane from which a branch lane is branched, an object preceding vehicle may move into the branch lane. In this case, it is necessary to exclude this object preceding vehicle from being the following control object for the own vehicle.

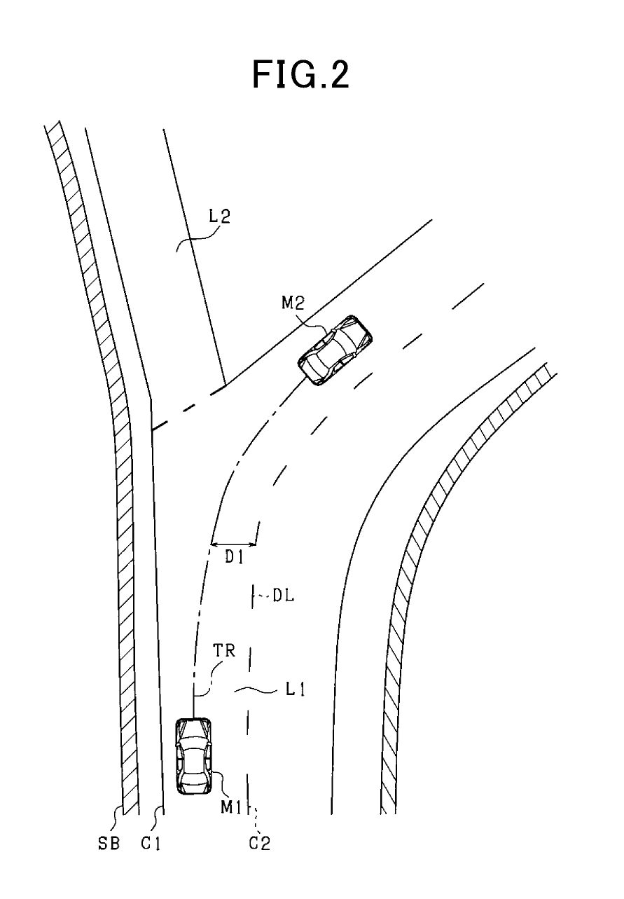

In a case where a branch line L2 branches from the own vehicle lane L1, and an object preceding vehicle M2 continues to travel in the own vehicle lane L1 without changing lanes as shown in FIG. 2, the movement track TR of the object preceding vehicle M2 follows the own vehicle lane L1. In this case, there is no change in the offset distance D1 between the movement track TR of the object preceding vehicle M2 and a lane marking C2 on the side opposite to a lane marking C1 on the side on which the branch lane L2 branches from the own vehicle lane L1.

On the other hand, in a case where the object preceding vehicle M2 moves to the branch lane L2 from the own vehicle lane L1, the movement track TR of the object preceding vehicle M2 follows the branch lane L2. In this case, the offset distance D1 between the movement track TR of the object preceding vehicle M2 and the lane marking C2 increases to D1b and to D1a in succession.

Generally, there is provided a stationary object SB that extends along a branched lane. Accordingly, in this embodiment, it is determined whether the object preceding vehicle M2 should be excluded from being the following control object for the own vehicle using such a stationary object SB.

As shown in FIG. 1, the object preceding vehicle determination unit 30 includes a branched lane determination section 31, a reference line selection section 32, an offset distance acquisition section 33 and a propriety determination section 34.

The branched lane determination section 31 determines that the own vehicle lane L1 is a branched lane if the stationary object acquisition section 26 acquires information regarding the stationary object SB, and determines that the own vehicle lane L1 is not a branched lane if the stationary object acquisition section 26 does not acquire information regarding a stationary object SB. The determination result of the branched lane determination section 31 is supplied to the reference line selection section 32.

If the branched lane determination section 31 determines that the own vehicle lane is a branched lane, the reference line selection section 32 selects, as a reference line, one of two lane markings acquired by the lane marking acquisition section 27, which is on the side opposite to the side on which a branch lane branches from the own vehicle lane.

The offset distance acquisition section 33 acquires a state quantity which is based on the offset distance between the reference line selected by the reference line selection section 32 and the movement track of the object preceding vehicle selected by the object preceding vehicle selection section 23. In this embodiment, the offset distance D1 between the reference line DL and the movement track TR of the object preceding vehicle is used as the state quantity as shown FIG. 2. The offset distance D1 can be obtained as the distance from the movement track TR of the object preceding vehicle to the intersection between the reference line DL and a perpendicular line of the movement track TR of the object preceding vehicle. Alternatively, the offset distance D1 may be obtained as the distance from the reference line DL to the intersection between the reference line DL and a perpendicular line of the movement track TR of the object preceding vehicle.

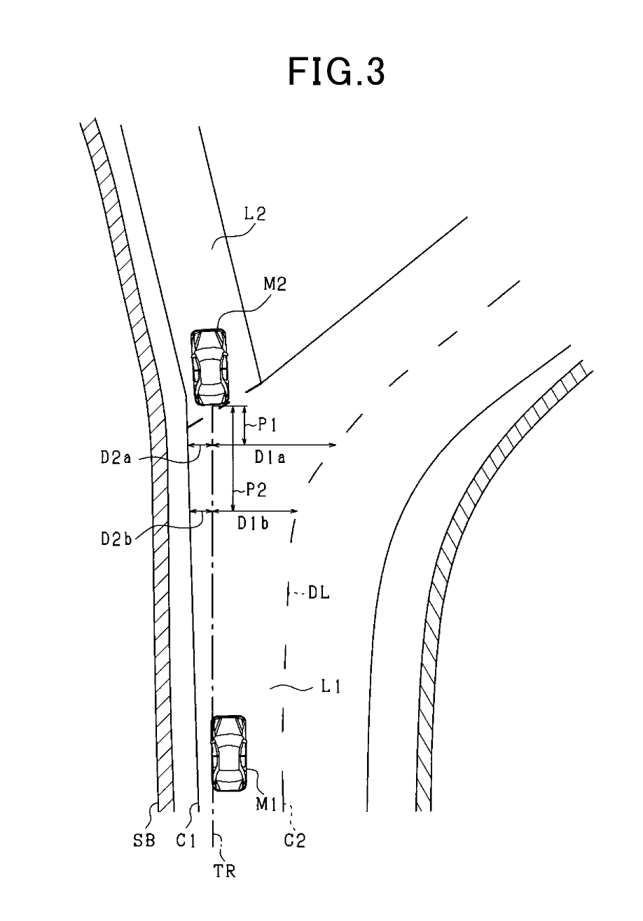

In this embodiment, the offset distance D1 is acquired for the position which is behind the current position of the object preceding vehicle M2 by a predetermined distance P1 (see FIG. 3). When the object preceding vehicle M2 moves to the branch lane, a change amount of the offset distance D1 is large in the vicinity of the current position of the object preceding vehicle M2. Accordingly, it is preferable that the predetermined distance P1 is set as small as possible so that the offset distance D1 is acquired for a position as close as possible to the current position of the object preceding vehicle M2. Alternatively, the offset distance D1 may be acquired for a position in front of the current position of the own vehicle M1 by a predetermined distance. The position for which the offset distance D1 is acquired may be set in accordance with the own vehicle speed (that is, the speed of the object preceding vehicle M2). For example, the position for which the offset distance D1 is acquired may be set such that it is more ahead of the current position of the own vehicle M1 as the own vehicle speed increases.

The state quantity based on the offset distance may be a change amount ΔD1 of the offset distance between the reference line DL and the movement track TR of the object preceding vehicle. For example, as shown in FIG. 3, the change mount ΔD1 can be calculated as the offset distance D1a at the position behind the current position of the object preceding vehicle M2 by the predetermined distance P1 minus the offset distance D1b at the position behind the current position of the object preceding vehicle M2 by a predetermined distance P2 (>P1), that is, as the change amount ΔD1 (=D1a−D1b).

Further, the state quantity may be calculated using the offset distance between the lane marking C1 on the side on which the branch line branches and the movement track TR of the object preceding vehicle M2. That is, as shown in FIG. 3, the difference of the deviation difference D2a between the movement track TR and the lane marking C1 at the position behind the current position of the object preceding vehicle M2 by the predetermined distance P1 and the deviation difference D2b between the movement track TR and the lane marking C1 at the position behind the current position of the object preceding vehicle M2 by the predetermined distance P2 is calculated as the change amount ΔD2 (=D2a−D2b). Next, the ratio of the change amount ΔD2 of the deviation difference between the movement track TR and the lane marking C1 to the change amount ΔD1 of the deviation difference between the movement track TR and the reference line DL is calculated. This ratio of ΔD1/ΔD2 may be used as the state quantity.

Returning to FIG. 1, the propriety determination section 34 determines that the object preceding vehicle M2 should be excluded from being the following control object for the own vehicle if the branched lane determination section 31 has determined that the own vehicle lane L1 is a branched lane, and the state quantity based on the offset distance D1 acquired by the offset distance acquisition section 33 exceeds a predetermined threshold Th, and otherwise determines that the object preceding vehicle M2 should be continued to be the following control object for the own vehicle. The object preceding vehicle determination unit 30 supplies the determination result of the propriety determination section 34 to the object preceding vehicle selection section 23.

The object preceding vehicle selection section 23 continues to select the object preceding vehicle M2 as the following control object for the own vehicle when the determination result supplied shows that the object preceding vehicle M2 should be continued to be the following control object. On the other hand, when the determination result supplied shows that the object preceding vehicle M2 should be excluded from being the following control object for the own vehicle, the object preceding vehicle selection section 23 excludes the object preceding vehicle M2 from being the following control object, and if another vehicle is travelling in the own vehicle lane ahead of the own vehicle, sets this vehicle as a new object preceding vehicle when a predetermined condition is satisfied.

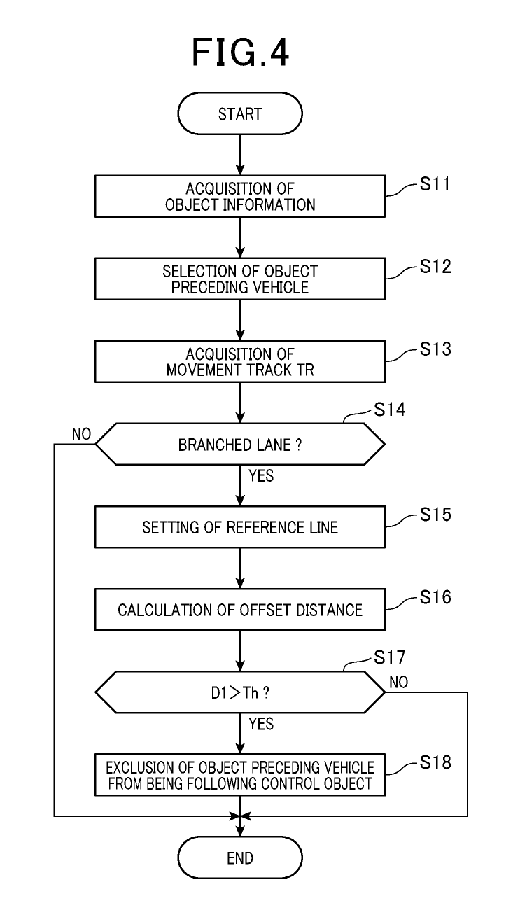

Next, the selection process of the object preceding vehicle M2, which is performed at regular time intervals by the vehicle control apparatus 20, is explained using the flowchart of FIG. 4 while referring to FIG. 3.

This process begins in step S11 where object information is acquired. Specifically, in this embodiment, preceding vehicles travelling ahead of the own vehicle M1, a stationary object SB provided along the own vehicle lane L1, or lane markings C1 and C2 on both sides of the own vehicle lane L1 are detected using image data supplied from the imaging device 11 and the ranging data supplied from the radar device 12. In subsequent step S12, an object preceding vehicle M2 is selected. Subsequently, the movement track TR of the selected object preceding vehicle M2 is acquired in step S13.

Next, in step S14, it is determined whether or not the own vehicle lane L1 is a branched lane. In this embodiment, the determination result in step S14 is affirmative when the stationary object SB has been detected. If the determination result in step 514 is negative, this process is terminated. In step S15 subsequent to step S14, a reference line DL is set. The lane marking C2 of the own vehicle lane L1 on the side opposite to the side on which the stationary object SB is detected (the side on which a branch lane L2 branches) is selected as the reference line DL. In subsequent step S16, an offset distance D1 between the reference line DL and the movement track TR of the object preceding vehicle is calculated.

Thereafter, it is determined in step S17 whether or not the offset distance D1 calculated in step S16 has exceeded a predetermined threshold Th. The threshold Th is set in advance by experimentally measuring the value of the offset distance D1 at a time when a preceding vehicle moves to the branch lane L2, for example.

If the determination result in step S17 is negative, this process is terminated. In this case, the object preceding vehicle M2 continues to be selected as the following control object. If the determination result in step S17 is affirmative, the process proceeds to step S18 where the object preceding vehicle M2 is excluded from being the following control object.

The vehicle control apparatus 20 described above provides the following advantages.

When the object preceding vehicle M2 moves to the branch lane L2 from the own vehicle lane L1 which is a single lane, since the movement track TR of the object preceding vehicle M2 follows the branch lane L2, there occurs an increase in the state quantity which is based on the offset distance between the movement track TR and the lane marking C2 (reference line DL) on the side opposite the side on which the branch lane L2 branches. Accordingly, the object preceding vehicle M2 can be excluded from being the following control object when the state quantity is detected to have exceed the threshold Th if the own vehicle lane has been determined to be a branched lane. Hence, the vehicle control apparatus 20 can perform a vehicle following control correctly even when the own vehicle lane is a branched lane.

Generally, branched lanes are provided with a stationary object SB such as a guardrail. Accordingly, by detecting such a stationary object SB, it is possible to determine whether or not the own vehicle lane is a branched lane.

The lane marking C2 on the side opposite to the side on which the stationary object SB is provided can be selected as the reference line DL.

The following control to control the own vehicle to follow the object preceding vehicle M2 can be continued while the state quantity based on the deviation difference between the reference line DL and the movement track TR of the object preceding vehicle M2 does not exceed the threshold Th.

The deviation difference between the reference line DL and the movement track TR of the object preceding vehicle M2 changes greatly when the object preceding vehicle M2 moves to the branch lane L2. Accordingly, the offset distance can be used as the state quantity.

It is possible to determine whether or not the object preceding vehicle M2 should be excluded from being the following control object based on the state quantity which is based on the difference between the reference line DL and the movement track TR of the object preceding vehicle M2. Hence, according to the above described embodiment of the invention, determination of whether or not the object preceding vehicle M2 should be excluded from being the following control object can be made with less cost compared to using a navigation system.

The above described embodiment may be modified as described below.

The step order of the flowchart of FIG. 4 may be changed. For example, step S14 and steps S15 to 17 may be reversed in the order of implementation.

In step S17 of the flowchart of FIG. 4, the threshold Th may be set differently in value between the first control process and the second control process. For example, it is possible that the threshold value used for the first control process is set to Th1 and the threshold value used for the second control process is set to Th2 which is different from Th1. In this case, it is preferable that Th1 is larger than Th2. This is because, if Th2 is small, fluctuation of the steering amount of the own vehicle M1 can be reduced sufficiently.

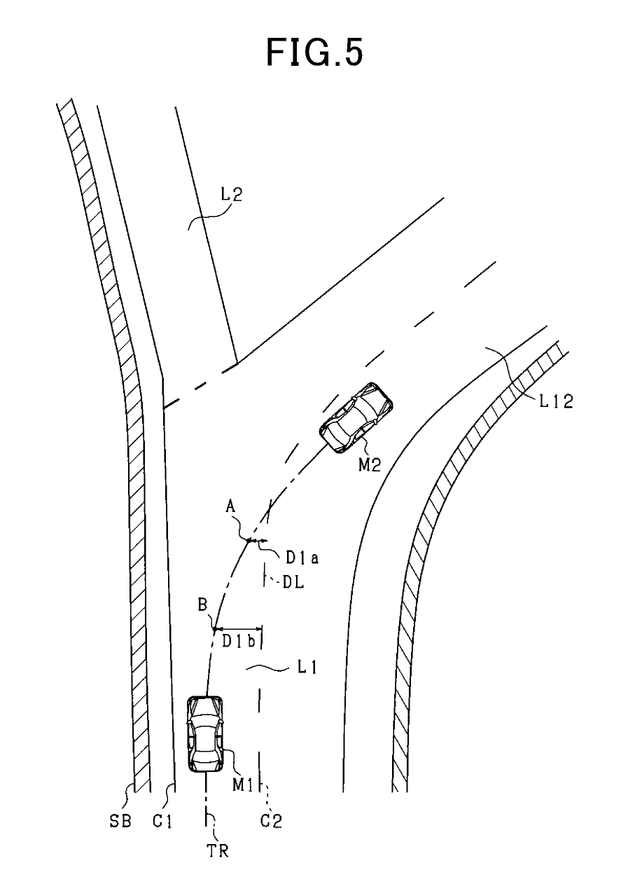

When the road on which the own vehicle M1 is running is a multi-lane road as shown in FIG. 5, it may occur that the object preceding vehicle M2 changes from the own vehicle lane L1 to the adjacent lane L12. Also in this case, the object preceding vehicle

M2 has to be excluded from being the following control object. When the object preceding vehicle M2 changes lanes like this, the offset distance D1 between the reference line DL and the movement track TR of the object preceding vehicle M2 decreases. Accordingly, the offset distance D1b at the moment when the object preceding vehicle M2 passes point B is smaller than the offset distance D1a at the moment when the object preceding vehicle M2 passes point A (see FIG. 5). Hence, it is possible to determine that the object preceding vehicle M2 has changed to the lane L12 by detecting a change of the offset distance. That is, the object preceding vehicle M2 can be excluded from being the following control object upon detecting a decrease of the offset distance D1 between the reference line DL and the movement track TR of the object preceding vehicle M2.

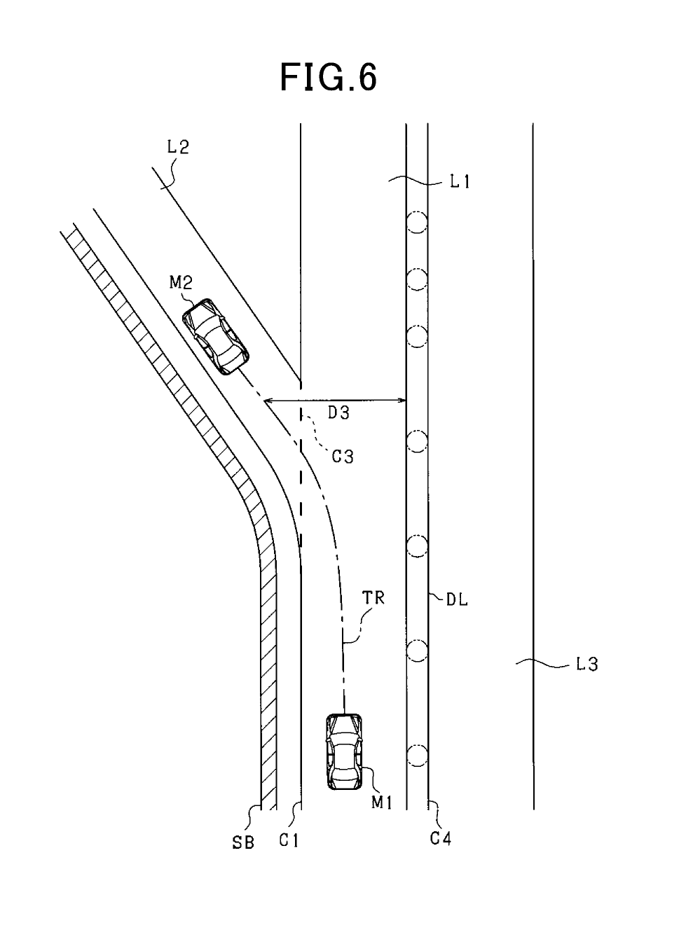

In a case where the road on which the own vehicle M1 is running is a single-lane road, a lane marking C4 showing a boundary with the opposite lane L3 is provided as shown in FIG. 6. The lane marking C4 is a yellow line or poles arranged in a line, for example. Accordingly, when the object preceding vehicle M2 changes to the branch lane L2 from the vehicle own lane L1 in this case, the offset distance D2 between the lane marking C4 and the movement track TR of the object preceding vehicle M2 increases.

Accordingly, it is possible to determine whether the object preceding vehicle M2 should be continued to be the following control object by detecting the offset distance D2 between the lane marking C4 and the movement track TR of the object preceding vehicle M2 in the case where the road on which the own vehicle M1 is running is a single-lane road, and the own vehicle lane L1 is a branched lane. Specifically, if the lane marking C4 showing a boundary with the opposite lane L3 is detected while the own vehicle lane L1 has been detected to be a branched lane, the own vehicle lane L1 is determined to be a single lane. In this case, the lane marking C4 is selected as the reference line DL, and it is determined whether or not the offset distance D2 between the reference line DL (or the lane marking line C4) and the movement track TR of the object preceding vehicle M2 exceeds the threshold Th. If the offset distance D2 is determined to exceed the threshold Th, the object preceding vehicle M2 is determined not to have changed to the branch lane L2, and otherwise determined to have changed to the branch lane L2.

As explained above, the lane marking C4 can be selected as the reference line DL in the case where the own vehicle lane L1 is a branched lane and is a single lane. In this case, by detecting a change of the state quantity which is based on the offset distance D2 between the lane marking C4 selected as the reference line DL and the movement track TR, it can be determined whether or not the object preceding vehicle M2 has changed to the branch lane L2.

The threshold Th may be set in accordance with the speed of the own vehicle M1 (or the speed of the object preceding vehicle M2). The first control process is such that the own vehicle M1 is controlled so that the following distance to the object preceding vehicle M2 increases as the speed of the own vehicle (or the speed of the object preceding vehicle M2) increases. Accordingly, according to the first control process, the offset distance D4a detected for the position which is behind the current position of the object preceding vehicle M2 by the predetermined distance P1 when the own vehicle speed is relatively high is larger than the offset distance D4b detected for the position which is behind the current position of the object preceding vehicle M2 by the predetermined distance P1 when the own vehicle speed is relatively low. Accordingly, it is preferable that the threshold Th is set so as to increase as the own vehicle speed increases. Also in a case where the offset distance D4 (D4a or D4b) is used as the state quantity which is based on the offset distance, the threshold Th may be set in accordance with the own vehicle speed.

By setting the threshold Th in accordance with the own vehicle speed, reliability of the determination of whether the object preceding vehicle M2 should be set as the following control object can be increased.

When the own vehicle lane L1 is a branched lane, there is a case where the own vehicle M1 changes to the branch lane L2. In this case, even when the object preceding vehicle M2 does not change to the branch lane L2 and continues to travel in the own vehicle lane L1, the object preceding vehicle M2 has to be excluded from being the following control object. When the own vehicle M1 changes to the branch lane L2, the driver of the own vehicle M1 operates a directional indicator of the own vehicle M1. Accordingly, it can be determined that the object preceding vehicle M2 has to be excluded from being the following control object upon detecting that the directional indicator has been operated, if the own vehicle lane has been determined to be a branched lane.

Generally, when the own vehicle lane is a leaving lane, the lane marking C1 on the side on which the stationary object SB is provided is a white line. Accordingly, it is possible to determine whether or not the own vehicle lane is a leaving lane by detecting the type of the lane marking on the side on which the stationary object SB is provided.

The branched lane determination section 31 may be configured to determine that the own vehicle lane is a branched lane upon detecting a branch lane marking C3 showing the branch lane L2. In this case, the reference line selection section 32 selects the lane marking C4 on the side opposite to the branch lane marking C3 as the reference line DL.

The above explained preferred embodiments are exemplary of the invention of the present application which is described solely by the claims appended below. It should be understood that modifications of the preferred embodiments may be made as would occur to one of skill in the art.

What is claimed is:

1. A vehicle control apparatus comprising:
a preceding vehicle detection section for detecting at least one preceding vehicle travelling ahead of an own vehicle;
a lane marking acquisition section for acquiring a lane marking formed along an own vehicle lane in which the own vehicle is travelling;
a movement track acquisition section for acquiring a movement track of an object preceding vehicle selected from the at least one preceding vehicle;
a vehicle control unit for controlling the own vehicle to travel following the object preceding vehicle as a following control object;
a branched lane determination section for determining whether or not the own vehicle lane is a branched lane;
a reference line selection section for selecting as a reference line the lane marking on a side opposite to a side on which the branch lane branches, and
a propriety determination section for excluding the object preceding vehicle from being the following control object if the own vehicle lane is determined to be a branched lane and a state quantity based on an offset distance between the movement track and the reference line exceeds a predetermined threshold.

2. The vehicle control apparatus according to claim 1, wherein the branched lane determination section determines that the own vehicle lane is a branched lane upon detecting a predetermined stationary object provided along the own vehicle lane.

3. The vehicle control apparatus according to claim 2, wherein the reference line selection section selects as the reference line the lane marking when the lane marking is on a side opposite to the stationary object.

4. The vehicle control apparatus according to claim 1, wherein the propriety determination section does not exclude the object preceding vehicle from being the following control object if the state quantity based on the offset distance between the movement track and the reference line does not exceed the threshold.

5. The vehicle control apparatus according to claim 1, further comprising an offset distance acquisition section for acquiring as the state quantity the offset distance between the movement track and the reference line.

6. The vehicle control apparatus according to claim 1, further comprising an offset distance acquisition section for acquiring as the state quantity a change amount of of the offset distance between the movement track and the reference line.

7. The vehicle control apparatus according to claim 1, wherein the vehicle control unit performs a first control process in which a speed of the own vehicle is controlled so that a distance between the own vehicle and the object preceding vehicle is maintained at a target distance and second control process in which a steering amount of the own vehicle is controlled such that the own vehicle is aligned to the object preceding vehicle in lateral position relative to a travel direction of the object preceding vehicle,
the threshold used by the propriety determination section being set such that the threshold is set to a first value to perform the first control process and set to a second value smaller than the first value to perform the second control process.

8. The vehicle control apparatus according to claim 1, wherein the threshold used by propriety determination section being set in accordance with a speed of the own vehicle.

9. The vehicle control apparatus according to claim 6, wherein the offset distance acquisition section determines that the object preceding vehicle has changed lanes upon detecting that the offset distance between the movement track of the object preceding vehicle and the reference line is decreasing, and the propriety determination section excludes the object preceding vehicle from being the following control object if the object preceding vehicle is determined to have changed lanes.

10. The vehicle control apparatus according to claim 1, wherein the reference line selection section selects as the reference line the lane marking when the lane marking is between the own vehicle lane and an opposite lane.

11. The vehicle control apparatus according to claim 1, wherein the reference line selection section selects as the reference line the lane marking when the lane marking is on a side opposite to a side on which a branch lane marking is provided between the branch lane and the own vehicle lane.
